(19) United States
(12) Patent Application Publication
(10) Pub. No.: US 2007/0026094 A1
(43) Pub. Date: Feb. 1, 2007

(54) Gas directing/exhausting structure

(75) Inventor: Ah-Yee Shu, Taoyuan Hsien (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/300,008

(22) Filed: Dec. 14, 2005

(30) Foreign Application Priority Data
Jul. 29, 2005 (TW) 094125930

(51) Int. Cl. B29C 31/10

(52) U.S. Cl. 425/130

(57) ABSTRACT

A gas directing/exhausting structure for use is an injection-molding system including a mold, a mold cavity and a channel. The gas directing/exhausting structure includes a head part and a rod body. The head part is accommodated within the channel and having a flat surface aligned with an edge of the channel. The head part has a first circumscribed radius. A first gas-flowing space is formed between the head part and the channel. The rod body is connected to the head part and partially accommodated within the channel. The rod body is substantially polygonal in shape but the intersect portion of every two adjacent edge surfaces has a corner rim. The rod body has a second circumscribed radius greater than the first circumscribed radius. The second gas-flowing space is formed between the rod body and the channel.

### FIELD OF THE INVENTION

The present invention relates to a gas directing/exhausting structure, and more particularly to a gas directing/exhausting structure of an injection-molding system.

### BACKGROUND OF THE INVENTION

Conventionally, an injection-molding machine is widely used to produce plastic molded articles. The injection-molding machine has a mechanism for melting the plastic material, and the molten plastic material is injected through a nozzle into the mold. Once the plastic material has cooled and solidified in the mold, the mold is then opened in order to allow the molded article to be removed. In the case that a pressurized gas is used in the injection-molding machine, another mechanism for directing/exhausting gas into/from the mold cavity is needed.

Referring to FIG. 1(a), an injection-molding system is partially illustrated. The injection-molding system 10 comprises a first mold half 11, a second mold half 12, a mold cavity 13, a channel 14 and a gas directing/exhausting structure 15. The mold cavity 13 is formed between the first mold half 11 and the second mold half 12. The mold cavity 13 has precise shape and dimension conforming to the plastic article to be injection molded from a plastic material therein. The channel 14 is penetrated through the second mold half 12 and communicated with the mold cavity 13. The gas directing/exhausting structure 15 principally comprises a rod body 150 and a sustaining part 151. The front portion of the rod body 150 is accommodated within the channel 14. The rear end of the rod body 150 is connected to the sustaining part 151, which is fixed by the clamping member 152.

In addition to directing/exhausting gas into/from the mold cavity, the directing/exhausting structure 15 is useful for assisting the molded article to be removed. Once the plastic material has cooled and solidified in the mold and the mold is then opened, an external force is applied on the clamping member 152 in the direction toward the second mold half 12 so that the rod body 150 is advanced within the channel 14 to push the molded article 16 out of the mold cavity 13.

Please refer to FIG. 1(b), which is a cross-sectional view of the injection-molding system of FIG. 1(a) taken along the line A′-A′. The rod body 150 of the gas directing/exhausting structure 15 is substantially cylindrical in shape and has a diameter slightly smaller than the channel 14. An annular space 17 is formed between the rod body 150 and the channel 14. Generally, the width of the annular space 17 is less than 0.04 mm for directing/exhausting gas into/from the mold cavity. If the width of the annular space 17 is too large, the molten plastic material may overflow into the annular space 17 during injection-molding. Once the plastic material has cooled and solidified in the mold cavity, the gas in the mold cavity will be vented or exhausted via the annular space 17. Moreover, for a purpose of smoothly moving the rod body 150 within the channel 14, a small amount of lubricant is filled in the annular space 17. The width of the annular space 17, which is less than 0.04 mm, allows for prevention of the lubricant from flowing into the mold cavity 13 to contaminate the molded article 16.

The rod body 150 of the gas directing/exhausting structure 15, however, is readily deviated from the position concentric to the channel 14. In other word, the eccentric rod body 150 results in varying width of the annular space 17, as can be seen in FIG. 1(c). Under this circumstance, the possible greatest width of the annular space 17 may be greater than 0.04 mm, and the possible smallest width of the annular space is close to zero. Due to the possible greatest width, not only the lubricant may flow into the mold cavity 13 to contaminate the molded article 16 but also the molten plastic material may overflow into the annular space 17 to result in a feathering edge of the molded article 16. In contrast, the gas in the mold cavity 13 fails to be smoothly exhausted through the possible smallest width of the annular space 17. Meanwhile, a back pressure is possible generated and applied to the mold cavity 13 to render deformation of the molded article 16. Moreover, abrasion is likely to occur due to the contact of the eccentric rod body 150 with the inner wall of the channel 14 and thus the shelf life of the directing/exhausting structure 15 is reduced.

In views of the above-described disadvantages resulted from the prior art, the applicant keeps on carving unflaggingly to develop an improved directing/exhausting structure of an injection-molding system according to the present invention through wholehearted experience and research.

### SUMMARY OF THE INVENTION

An object of the present invention is to provide a gas directing/exhausting structure of an injection-molding system for assisting the molded article to be removed.

Another object of the present invention is to provide a gas directing/exhausting structure of an injection-molding system to overcome the problem of eccentricity, thereby avoiding contamination, deformation and feathering edge of the molded article.

In accordance with an aspect of the present invention, there is provided a gas directing/exhausting structure of an injection-molding system. The injection-molding system comprising a mold, a mold cavity formed in the mold, and a channel communicated with the mold cavity. The gas directing/exhausting structure comprises a head part and a rod body. The head part is accommodated within the channel and having a flat surface aligned with an edge of the channel. The head part has a first circumscribed radius. A first gas-flowing space is formed between the head part and the channel. The rod body is connected to the head part and partially accommodated within the channel. The rod body is substantially polygonal in shape but the intersect portion of every two adjacent edge surfaces has a corner rim. The rod body has a second circumscribed radius greater than the first circumscribed radius. The second gas-flowing space is formed between the rod body and the channel.

In accordance with an aspect of the present invention, there is provided a dual directing/exhausting device for use in an injection-molding system. The injection-molding system comprises a mold, a mold cavity formed in the mold, and a channel communicated with the mold cavity. The dual directing/exhausting structure comprises a first gas directing/exhausting structure and a second gas directing/exhausting structure. The first gas directing/exhausting structure is partially accommodated within the channel and having a flat surface aligned with an edge of the channel, and comprises a sleeve body with a receptacle. A first gas-flowing space is formed between the sleeve body and the channel. The second gas directing/exhausting structure is partially accommodated within the receptacle, and comprises a head part and a rod body. The head part is protruded into the mold cavity and has a first circumscribed radius. The rod body is substantially polygonal in shape but the intersect portion of every two adjacent edge surfaces has a corner rim. The rod body has a second circumscribed radius greater than the first circumscribed radius. A second gas-flowing space is formed between the rod body and the receptacle.

The above contents of the present invention will become more readily apparent to those ordinarily skilled in the art after reviewing the following detailed description and accompanying drawings, in which:

### BRIEF DESCRIPTION OF THE DRAWINGS

FIG. 1(a) is a front view of a conventional injection-molding system;

FIG. 1(b) is a cross-sectional view of the injection-molding system of FIG. 1(a) taken along the line A′-A′;

FIG. 1(c) is a cross-sectional view of the injection-molding system of FIG. 1(a) taken along the line A′-A′ in a case of an eccentric gas directing/exhausting structure;

FIG. 2(a) is a front view of an injection-molding system according to a preferred embodiment of the present invention;

FIG. 2(b) is a perspective view of a gas directing/exhausting structure used in the injection-molding system of FIG. 2(a);

FIG. 2(c) is a cross-sectional view of the injection-molding system of FIG. 2(a) taken along the line A′-A′;

FIG. 2(d) is a cross-sectional view of the injection-molding system of FIG. 2(a) taken along the line B′-B′;

FIG. 2(e) is a schematic view illustrating relative locations of the head part and the rod body of the gas directing/exhausting structure;

FIG. 3(a) is a front view of an injection-molding system according to another preferred embodiment of the present invention;

FIG. 3(b) is a front view of a dual directing/exhausting device used in the injection-molding system of FIG. 3(a);

FIG. 3(c) is a side view of the first gas directing/exhausting structure of the dual directing/exhausting device in FIG. 3(b);

FIG. 3(d) is a side view of the second gas directing/exhausting structure of the dual directing/exhausting device in FIG. 3(b); and

FIG. 3(e) is a cross-sectional view of the injection-molding system of FIG. 2(a) taken along the line A′-A′.

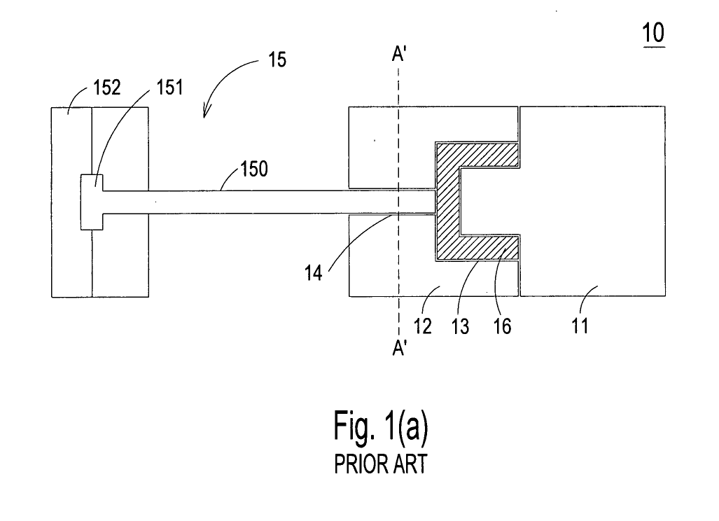

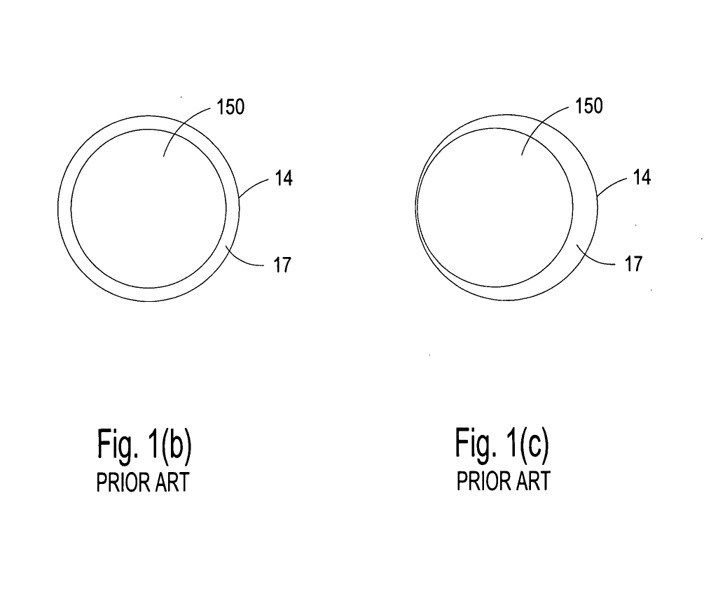

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

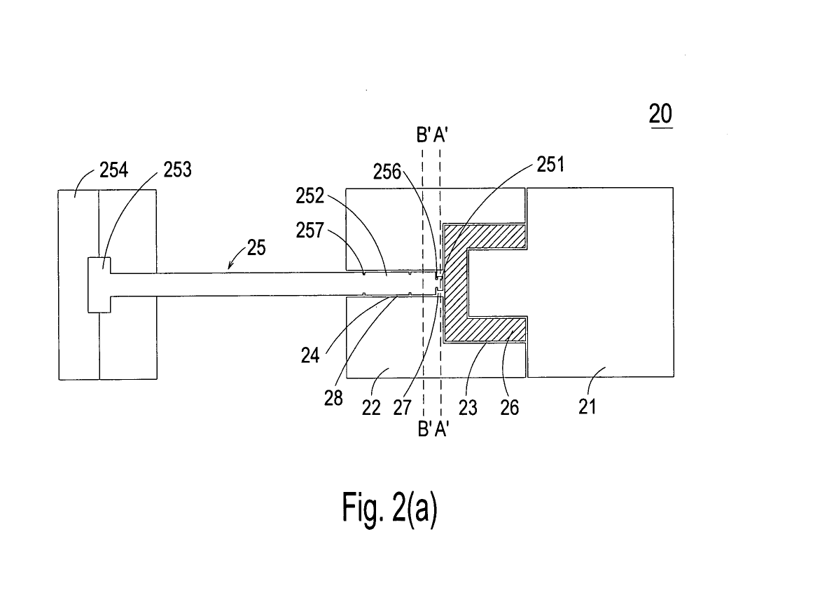

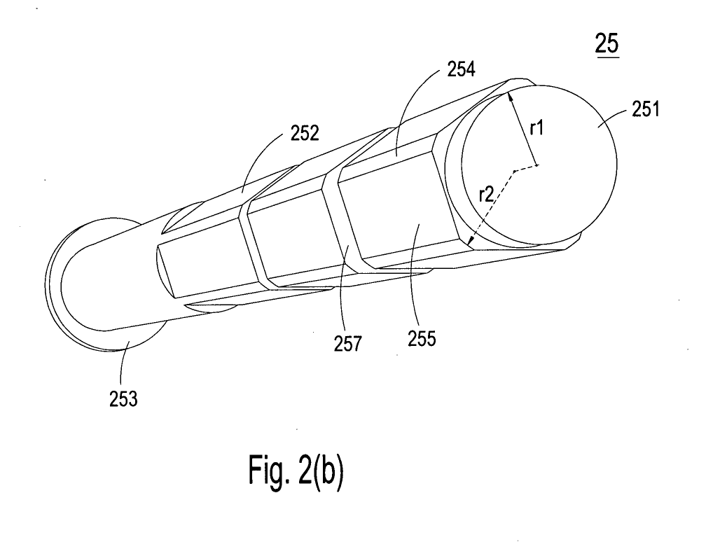

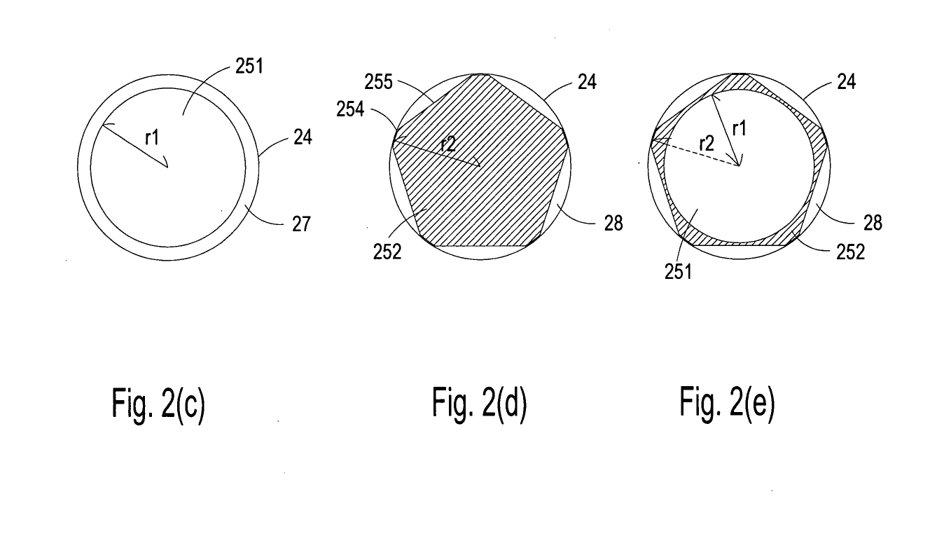

Referring to FIG. 2(a), an injection-molding system according to a preferred embodiment of the present embodiment is partially illustrated. The injection-molding system 20 comprises a first mold half 21, a second mold half 22, a mold cavity 23, a channel 24 and a gas directing/exhausting structure 25. The mold cavity 23 is formed between the first mold half 21 and the second mold half 22. The mold cavity 23 has precise shape and dimension conforming to the plastic article to be injection molded from a plastic material therein. The channel 24 is penetrated through the second mold half 22 and communicated with the mold cavity 23. Alternatively, the channel 24 may be penetrated through the first mold half 21 and communicated with the mold cavity 23.

As shown in FIGS. 2(a) and 2(b), the gas directing/exhausting structure 25 principally comprises a head part 251, a rod body 252 and a sustaining part 253. The head part 251 and the sustaining part 253 are arranged at the front and rear ends of the rod body 252, respectively. It is preferred that the head part 251, the rod body 252 and the sustaining part 253 are integrally formed into one piece. The head part 251 and a portion of the rod body 252 are accommodated within the channel 24. The head part 251 has a flat surface aligned with an edge of the channel 24 so as to be in close contact to the mold cavity 23. The sustaining part 253 is fixed by using a clamping member 254.

In addition to directing/exhausting gas into/from the mold cavity 23, the directing/exhausting structure 25 is useful for assisting the molded article to be removed. Once the plastic material has cooled and solidified in the mold cavity 23 and the mold is then opened, an external force is applied on the clamping member 254 in the direction toward the second mold half 22 so that the rod body 252 is advanced within the channel 24 and the head part 251 pushes the molded article 26 out of the mold cavity 23.

Please refer to FIGS. 2(c) and 2(a). The head part 251 is substantially cylindrical in shape and has a radius r1. An annular space 27 is formed between the head part 251 and the channel 24.

Please refer to FIGS. 2(d) and 2(a). The rod body 252 is substantially pentagonal in shape but the intersect portion of every two adjacent edge surfaces 255 has a corner rim 254. The distance between the center of the rod body 252 and the corner rim 254 indicates a circumscribed radius r2. As a result, another gas-flowing space 28 is formed between the edge surface 255 and the channel 24. Since the corner rim 255 is distant from the inner wall of the channel 24 and the corner rims 254 are the possible contact regions between the rod body 252 and the channel 24, the abrasion will be largely reduced and thus the shelf life of the directing/exhausting structure 25 is extended. Moreover, since the corner rims 254 are in close contact with inner wall of the channel 24, the circumscribed radius r2 of the rod body 252 is substantially equal to the radius of the channel 24. Under this circumstance, the rod body 252 will be concentrically moved along the channel 24. Consequently, the problems of causing feathering edge of the molded article 26 due to eccentricity are solved.

Please refer to FIGS. 2(a), 2(c), 2(d) and 2(e). It is preferred that the difference between r2 and r1 is less than 0.04 mm. Once the plastic material has cooled and solidified in the mold cavity 23, the gas in the mold cavity 23 will be vent or exhausted via the annular space 27 and then the gas-flowing space 28. Optionally, an indentation 256 is provided at the interface between the head part 251 and the rod body 252 so as to avoid gas accumulation in the mold cavity and generation of the back pressure.

Please refer to FIGS. 2(b) and 2(a) again. For a purpose of smoothly moving the rod body 252 within the channel 24, a small amount of lubricant (not shown) is filled in the gas-flowing space 28. Optionally, at least one trench 257 is provided in the rod body 252 to collect the lubricant possibly flowing into the mold cavity upon movement of the rod body 252, thereby preventing contamination of the molded article 26. In an embodiment, the depth and the width of the trench 257 are 0.2 mm and 10 mm, respectively. Depending on the length of the rod body 252, the trench number is varied. As the length of the rod body 252 is increased, the number of the trench 257 will be increased.

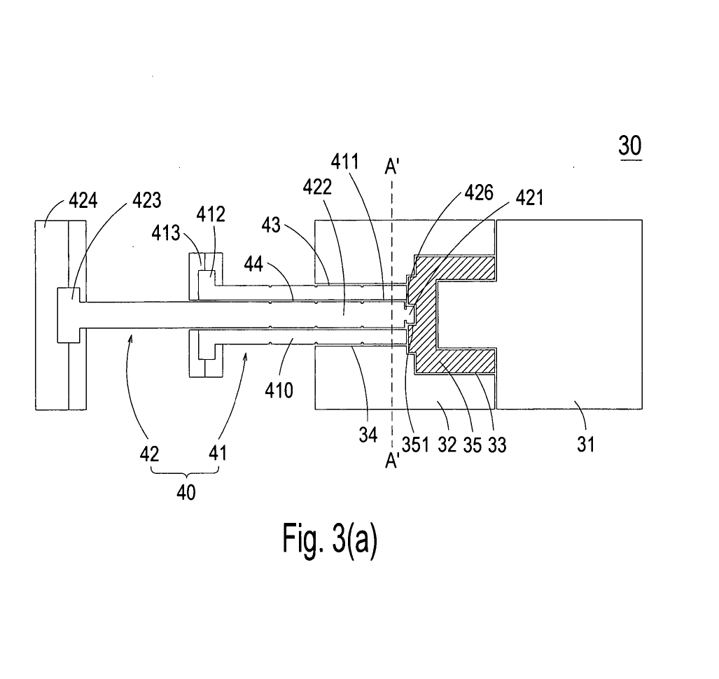

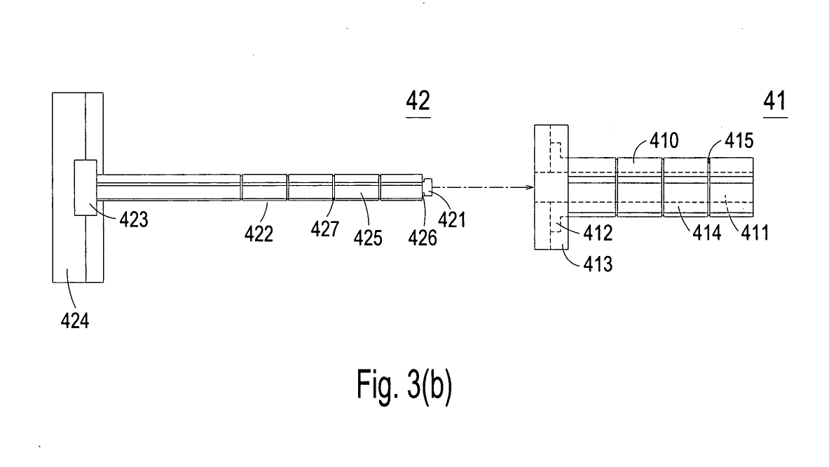

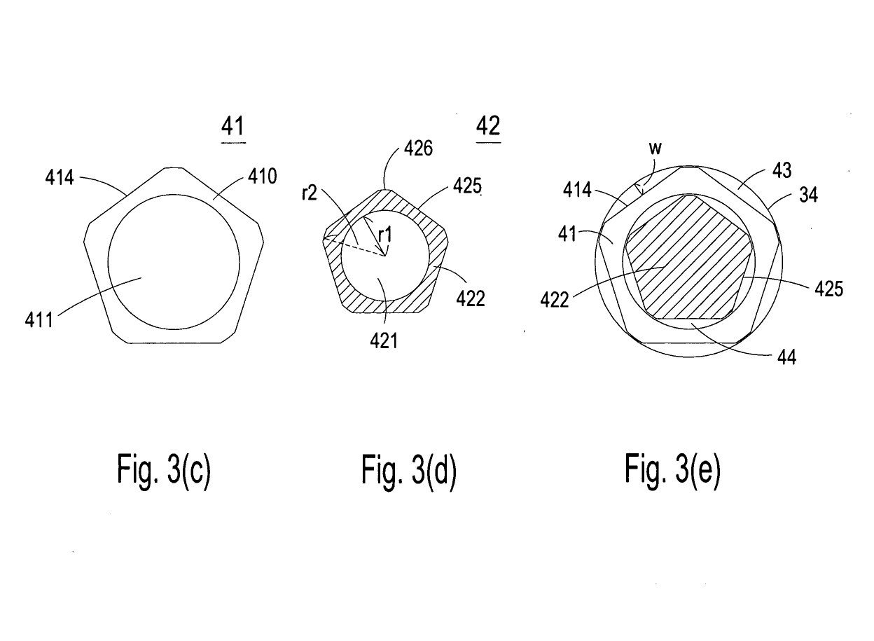

Referring to FIG. 3(a), a further embodiment of an injection-molding system according to the present embodiment is partially illustrated. The injection-molding system 30 comprises a first mold half 31, a second mold half 32, a mold cavity 33, a channel 34 and a dual directing/exhausting device 40. The mold cavity 33 is formed between the first mold half 31 and the second mold half 32. The mold cavity 33 has precise shape and dimension conforming to the plastic article to be injection molded from a plastic material therein. The channel 34 is penetrated through the second mold half 32 and communicated with the mold cavity 33. Alternatively, the channel 34 is penetrated through the first mold half 32.

Referring to FIGS. 3(a) and 3(b), the dual directing/exhausting device 40 comprises a first gas directing/exhausting structure 41 and a second gas directing/exhausting structure 42.

The first gas directing/exhausting structure 41 is substantially a sleeve including a sleeve body 410 with a receptacle 411 and a first sustaining part 412. The first sustaining part 412 is connected to the rear end of the sleeve body 410 and fixed by a clamping member 413. The receptacle 411 is also penetrated through the sustaining part 412 and the clamping member 413. The front end of the sleeve body 410 is aligned with an edge of the channel 34 so as to be in close contact to the mold cavity 33.

The second gas directing/exhausting structure 42 principally comprises a head part 421, a rod body 422 and a second sustaining part 423. The head part 421 and the second sustaining part 423 are arranged at the front and rear ends of the rod body 422, respectively. It is preferred that the head part 421, the rod body 422 and the sustaining part 423 are integrally formed into one piece. The second sustaining part 423 is fixed by using a clamping member 424. A portion of the rod body 422 is accommodated within the receptacle 411 of the first gas directing/exhausting structure 41. The head part 421 of the second gas directing/exhausting structure 42 is protruded outside the receptacle 411 and into the mold cavity 33, so that a molded article 35 with a bore 351 corresponding to the location of the head part 421 may be produced. Once the plastic material has cooled and solidified in the mold cavity 33 and the mold is then opened, an external force is applied on the first clamping member 413 in the direction toward the second mold half 32 so that the sleeve body 410 of the first gas directing/exhausting structure 41 is advanced within the channel 34 and pushes the molded article 35 out of the mold cavity 33.

Please refer to FIGS. 3(c), 3(d) and 3(e). In this embodiment, the sleeve body 410 of the first gas directing/exhausting structure 41 is substantially pentagonal in shape but the intersect portion of every two adjacent edge surfaces 414 has a corner rim 415. Similarly, the rod body 422 of the second gas directing/exhausting structure 42 is substantially pentagonal in shape but the intersect portion of every two adjacent edge surfaces 425 has a corner rim 426. The head part 421 is substantially cylindrical in shape and has a circumscribed radius r1. The rod body 422 has a circumscribed radius r2. It is preferred that the difference between r2 and r1 is less than 0.04 mm. A first gas-flowing space 43 is formed between the edges surfaces 414 of the first gas directing/exhausting structure 41 and the channel 34. The width w of the first gas-flowing space 43, i.e. the distance between the edge surface 414 and the channel 34, is preferably less than 0.04 mm. Whereas, a second gas-flowing space 44 is formed between the edges surfaces 425 of the second gas directing/exhausting structure 42 and the receptacle 411 of the first gas directing/exhausting structure 41. Since the possible contact regions between the edge surfaces 414 and the inner walls of the channel 34 and the possible contact regions between the edge surfaces 425 and the inner walls of the receptacle 411 are reduced, the abrasion will be largely reduced and the shelf lives of the directing/exhausting structures 41 and 42 are extended. Moreover, since the corner rims 415 and 426 are in close contact with inner wall of the channel 34 and the receptacle 411, respectively, the sleeve body 410 will be concentrically moved along the channel 34. Consequently, the problems of causing feathering edge of the molded article 35 due to eccentricity are solved.

Once the plastic material has cooled and solidified in the mold cavity 33, the gas in the mold cavity 33 will be vented or exhausted via the first gas-flowing space 43 and the second gas-flowing space 44. Optionally, an indentation 426 is provided at the interface between the head part 421 and the rod body 422 so as to avoid gas accumulation in the mold cavity and generation of the back pressure.

Please refer to FIGS. 3(a) and 3(b) again. For a purpose of smoothly moving the sleeve body 410 of the first gas directing/exhausting structure 41 within the channel 34, a small amount of lubricant (not shown) is filled in the first gas-flowing space 43. Optionally, at least one trench 415 is provided in the sleeve body 410 to collect the lubricant possibly flowing into the mold cavity 33 upon movement of the sleeve body 410, thereby preventing contamination of the molded article 35. Likewise, a small amount of lubricant (not shown) is filled in the second gas-flowing space 44 and at least one trench 427 is optionally provided in the rod body 422 of the second gas directing/exhausting structure 42. In an embodiment, the depth and the width of the trench 415 or 427 are 0.2 mm and 10 mm, respectively. Depending on the length of the sleeve body 410 and the rod body 422, the trench number is varied. As the length of the sleeve body 410 or the rod body 422 is increased, the number of the trench 415 or 427 will be increased.

From the above description, the gas directing/exhausting structure and the dual directing/exhausting device of the present invention are capable of assisting the molded article to be removed. Moreover, since the problem of eccentricity is overcome, the contamination, deformation and feathering edge of the molded article are minimized. Since the abrasion is largely reduced, the shelf life of the directing/exhausting structure is extended.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A gas directing/exhausting structure of an injection-molding system, said injection-molding system comprising a mold, a mold cavity formed in said mold, and a channel communicated with said mold cavity, said gas directing/exhausting structure comprising:
a head part accommodated within said channel and having a flat surface aligned with an edge of said channel, wherein said head part has a first circumscribed radius, and a first gas-flowing space is formed between said head part and said channel; and
a rod body connected to said head part and partially accommodated within said channel, said rod body being substantially polygonal in shape but the intersect portion of every two adjacent edge surfaces has a corner rim, wherein said rod body has a second circumscribed radius greater than said first circumscribed radius, and a second gas-flowing space is formed between said rod body and said channel.

2. The gas directing/exhausting structure according to claim 1 further comprising a sustaining part connected to said rod body and fixed by a clamping member.

3. The gas directing/exhausting structure according to claim 2 wherein said head part, said rod body and said sustaining part are integrally formed into one piece.

4. The gas directing/exhausting structure according to claim 2 wherein said rod body is advanced within said channel to push a molded article out of said mold cavity when an external force is applied on said clamping member.

5. The gas directing/exhausting structure according to claim 1 wherein a difference between said second circumscribed radius and said first circumscribed radius is less than 0.04 mm.

6. The gas directing/exhausting structure according to claim 1 wherein an indentation is provided at the interface between said head part and said rod body for facilitating guiding gas through said first and second gas-flowing spaces.

7. The gas directing/exhausting structure according to claim 1 wherein said rod body further comprises at least one trench to collect the lubricant filled in said second gas-flowing space.

8. The gas directing/exhausting structure according to claim 1 wherein said mold includes a first mold half and a second mold half, and said channel is penetrated through either of said first mold half and said second mold half.

9. The gas directing/exhausting structure according to claim 1 wherein said second circumscribed radius of said rod body is substantially equal to the radius of said channel.

10. A dual directing/exhausting device for use in an injection-molding system, said injection-molding system comprising a mold, a mold cavity formed in said mold, and a channel communicated with said mold cavity, said dual directing/exhausting structure comprising:
a first gas directing/exhausting structure partially accommodated within said channel and having a flat surface aligned with an edge of said channel, and comprising a sleeve body with a receptacle, wherein a first gas-flowing space is formed between said sleeve body and said channel; and
a second gas directing/exhausting structure partially accommodated within said receptacle, and comprising a head part and a rod body, wherein said head part is protruded into said mold cavity and has a first circumscribed radius, wherein said rod body is substantially polygonal in shape but the intersect portion of every two adjacent edge surfaces has a corner rim, said rod body has a second circumscribed radius greater than said first circumscribed radius, and a second gas-flowing space is formed between said rod body and said receptacle.

11. The dual directing/exhausting device according to claim 10 wherein said first gas directing/exhausting structure further comprises a first sustaining part connected to said sleeve body and fixed by a clamping member.

12. The dual directing/exhausting device according to claim 11 wherein said sleeve body is advanced within said channel to push a molded article out of said mold cavity when an external force is applied on said clamping member.

13. The dual directing/exhausting device according to claim 10 wherein said sleeve body of said first gas directing/exhausting structure further comprises at least one trench to collect the lubricant filled in said first gas-flowing space.

14. The dual directing/exhausting device according to claim 10 wherein said sleeve body is substantially polygonal in shape but the intersect portion of every two adjacent edge surfaces has a corner rim, wherein the distance between said edge surface and said channel is less than 0.04 mm.

15. The dual directing/exhausting device according to claim 10 wherein a difference between said second circumscribed radius and said first circumscribed radius is less than 0.04 mm.

16. The dual directing/exhausting device according to claim 10 wherein said second gas directing/exhausting structure further comprises an indentation at the interface between said head part and said rod body for facilitating guiding gas through said second gas-flowing space.

17. The dual directing/exhausting device according to claim 10 wherein said second gas directing/exhausting structure further comprises a second sustaining part connected to said rod body and fixed by a clamping member.

18. The dual directing/exhausting device according to claim 10 wherein said rod body of said second gas directing/exhausting structure further comprises at least one trench to collect the lubricant filled in said second gas-flowing space.

19. The dual directing/exhausting device according to claim 10 wherein said mold includes a first mold half and a second mold half, and said channel is penetrated through either of said first mold half and said second mold half.

20. The gas directing/exhausting structure according to claim 10 wherein said second circumscribed radius of said rod body is substantially equal to the radius of said receptacle.
